(19) United States
(12) Patent Application Publication
(10) Pub. No.: US 2009/0217683 A1
(43) Pub. Date: Sep. 3, 2009

(54) Food Stuff Dispenser Integrated into a Refrigerator Housing

(75) Inventors: Alphan Manas, Istanbul (TR); Kerem Guvenc, Istanbul (TR); Murat Armagan, Istanbul (TR)

Correspondence Address: AKERMAN SENTERFITT, P.O. BOX 3188, WEST PALM BEACH, FL, 33402-3188, US

(73) Assignee: Teknoloji Dizayn Studyo Produksiyon Ve Reklamchlik Anonim Sirketi, Istanbul (TR)

(21) Appl. No.: 11/911,180

(22) PCT Filed: Sep. 15, 2005
(86) PCT No.: PCT/TR05/00045

§ 371 Date: Mar. 27, 2008

(30) Foreign Application Priority Data
Apr. 13, 2005 (TR) 2005/01346
Apr. 29, 2005 (TR) 2005/01588
Jul. 12, 2005 (TR) 2005/02707

(51) Int. Cl. G01K 13/00; F25D 23/02; F25B 49/00; B67D 5/62

(52) U.S. Cl. 62/129; 62/449; 62/132; 62/389

(57) ABSTRACT

The apparatus provides a food storage and presentation mechanism, which preserves the food stuff and provides a handy way to take out the desired amount of food when necessary, where by the food stuff is stored in cartridges positioned in a housing. The cartridges can easily removed from their receiving slots and can be filled with food/food stuff. Furthermore, the apparatus allows liquid drinks such as fruit juice etc. to be taken out of the unit without taking the box out by positioning the said box packages, which allows the self packages of the drinks to be used.

### TECHNICAL FIELD

Present Invention is about a food storage and presentation mechanism that can produce data about the stored food amount, and it is developed to store and use dry or watery food stuff.

### PRIOR TECHNIQUE

In present applications, food stuff are being preserved in refrigerators, various cooling units, in a cabinet or any other media, and present bag, package, covering of the food or a separate jar or a preserving pot is used.

When the food stuff are thought that they are to be preserved in their own bag or covering, the said packages are getting deformed and being torn or getting pierced from a weak part of the package, because the bags and coverings in the market are not enduring or they get old of being continuously used. Whereon, the dry food stuff are scattered inside the cooling unit or cabinet and they cause situations that can hardly be cleaned.

Preservation of the food stuff in separate jars or preserving pots in cooling units or cabinets also causes some drawbacks in usage, besides the point of view of untidy and scattered appearance in the unit. While taking the pot out of the cabinet or refrigerator, possibility of falling down and breaking of a glass pot by slipping through hand, and mixing of the dry food and glass pieces, is always there and it is such a bad situation that many people face. Preserving the food in an unbreakable plastic preserving pot causes some drawbacks in the point of view of energy spent and the long time preservation of the food stuff, because the unused part of the food also have to be taken out of the unit wholly and it has to be rest in the outside environment to equalize with the environmental temperature, and again it has to be put back into the unit.

Various vegetable oils should be preserved in cooling units to be kept and consumed healthy. In prior technique, the said products were placed on the racks in the cooling units.

Those products that are not fixed in the cooling units falls down and spread around, thus damage the cooling unit. In addition to that, expiration dates of the products and the stock amounts cannot be followed, and so the products spoil even before they are consumed. Nonetheless, the products are taken out in their packages to be used and consumed.

The liquid food stuff that are stored in the cooling units are stored in their packages and stored as piles. The products are taken out and used, when they are to be consumed. Because the expiration dates of the said products cannot be checked regularly, the products that are expired become unusable before they are consumed, and the product consuming costs rise.

In patent numbered U.S. Pat. No. 6,039,219 is mentioned an apparatus that is especially used to serve out the frequently consumed liquids such as milk and fruit juices. It is mentioned that it comprises a control member—a handle for the disposable packages or re-usable packages to be settled in the slot to take out the liquids in desired amounts.

In conclusion, the necessity of a food storage mechanism that provides preservation of the food stuff in cooling units or in any other media, that offers a handy way to take out the food stuff in desired amounts by the user, and which has the ability to produce the data that informs the user about the remaining amount of food, and has the ability to follow the stocks, and the inadequacy of the present solutions make it obligatory to have technical improvements in technical field.

### BRIEF DESCRIPTION OF THE INVENTION

The present invention is about the food storage mechanism that meets the above requirements eliminating all the disadvantages and bringing new advantages.

The purpose of the invention is to introduce a food storage and presentation mechanism, which preserves the food stuff and provides a handy way to take out the desired amount of food when necessary.

Another purpose of the invention is to introduce a food storage and presentation mechanism, where the food stuff are stored in preset compartments positioned in the body instead of their own packages or coverings, and the said compartments can practically removed from their slots and can be filled with food/food stuff, and the compartments can easily settled back to their slots and can get easily get ready to use.

Another purpose of the invention is to introduce a food storage and presentation mechanism, which allows liquid drinks such as fruit juice etc. to be taken out of the unit without taking the box out by positioning the said box packages, which allows the self packages of the drinks to be used.

Another purpose of the invention is to introduce a food storage and presentation mechanism, where the food stuff are stored in compartments that are positioned in a body, where the data about the food stuff in the said compartments can be produced and can be sent to a control unit.

Another purpose of the invention is to introduce a food storage and presentation mechanism, which allows to position the food stuff in their own packages or in a preserving compartment in a closed media, and allows to take the food stuff out practically and in desired amounts when needed, not necessarily taking the said compartments or packages out.

To achieve all the advantages that are said above and will be clarified from the explanations below, the present invention is a mechanism to store the food especially in cooling units, and it comprises a food storage compartment a compartment slot that is needed by the food storage compartment to be attached and de-attached on the storage mechanism, a compartment opening to fill and empty the food stuff into the compartment, and a control member that allows to take the food stuff out from the compartment easily.

A preferable embodiment of the invention also comprises a compartment opening stopper, and after the food storage compartment is filled, the stopper is placed on the food storage compartment opening and is closed and reversed and settled into the compartment slot.

A preferable embodiment of the invention also comprises a quantity sensor to determine the food amount that is placed in the compartment.

In a preferable embodiment of the invention, also the quantity sensor is made by putting an insulator between two conductive panels.

A preferable embodiment of the invention also comprises connection ends (1.4.4) in order to sense the changes in the electric current, when the quantity sensor produces different electric currents depending on the pressure that is applied by the food stuff placed in the said compartment.

A preferable embodiment of the invention also comprises electrical connection slots for each connection end that transmit the electrical information to the related parts of the cooling unit.

A preferable embodiment of the invention also comprises a food egress in compartment slot, and is an electrical mechanism that opens or closes the said food egress, when the control member is pushed or pulled.

A preferable embodiment of the invention also requires the placement of a liquid transfer channel inside the food storage compartment in order to suck preferably the liquid food stuff from the compartment by pump, and the food storage compartment is settled into the compartment slot by using a fixing latch.

A preferable embodiment of the invention also connects the control member with the liquid transfer channel, especially for the liquid food stuff.

A preferable embodiment of the Invention also comprises a liquid discharging channel, which is connected to the control member in one end and connected to a product presentation compartment in the other end.

A preferable embodiment of the invention also comprises a storing mechanism that allows a number of distribution compartments to be stored, preferably in the cooling unit, side by side or back of each other.

A preferable embodiment of the invention also comprises a compartment slot connection member on which the compartment slots can be positioned in desired order.

A preferable embodiment of the invention also comprises a cover, which is positioned in front of the compartment slot connection member, and which constitutes the external appearance and comprises a body, which allows the storing mechanism to be positioned in the cooling unit and allow it to work as a separate unit when desired.

A preferable embodiment of the invention also comprises an information lamp that is positioned on the compartment and/or compartment slot in order to inform the user by warning light about the expiration date of the product, according to the product data entered from the control unit.

The structural and characteristic properties of the invention and all of its advantages will be clarified by the figures given below and the detailed explanations about those figures and therefore, evaluation should be done considering these figures and detailed explanations.

### BRIEF DESCRIPTION OF THE FIGURES

FIG. 1 depicts a perspective view of food storage compartment.

FIGS. 2a, b depicts a perspective figure that shows the food storage compartment and the slot in which the compartment will be positioned and the relation between those.

FIG. 3 depicts a cross-sectional view of taking the food out of the food storage compartment.

FIGS. 4a, b, c depicts a preferable embodiment of the food storage mechanism of said invention.

FIGS. 5a, b, depicts perspective pictures of another preferable embodiment of the said invention.

FIG. 6 depicts a front view of another preferable embodiment the food storage mechanism of the said invention.

### REFERENCE NUMBERS USED IN THE FIGURES

1. Food storage compartment
1.1 Etiquette field
1.2 Compartment opening
1.3 Compartment opening stopper
1.4 Quantity sensor
1.4.1 Conductor panels
1.4.2 Insulator member
1.4.3 Conductive bands
1.4.4 Connection ends
2. Compartment Slot
2.1 Etiquette field
2.2 Control member
2.3 Electrical connection slots
2.4 Food egress
3. Storing mechanism
3.1 Compartment slot connection member
3.2 Cover
3.3 Body
4. Liquid transfer channel
5. Fixing latch
6. Product presentation compartment
7. Liquid discharge channel
8. Information lamp

### DETAILED EXPLANATION OF THE INVENTION

In this detailed explanation, the preferred embodiment of the food storing and presentation mechanism, which is the subject of this invention, is explained as an example aiming to clarify the subject without producing any limiting effect.

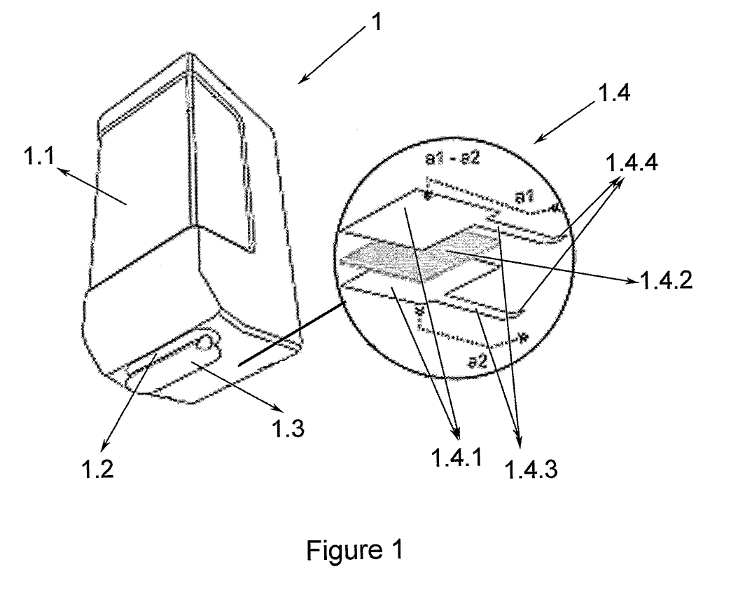

The food storage compartment (1) seen in FIG. 1 basically comprises an etiquette field (1.1) In front side, where a preferably picture etiquette can be stick, signifying what kind of food is inside, also comprises a compartment opening (1.2) to fill and then take out the food, a compartment opening stopper (1.3) that prevents the food from falling down after filling, a quantity sensor (1.4) that produces electrical information about the quantity of the food according to the pressure applied by the food stuff.

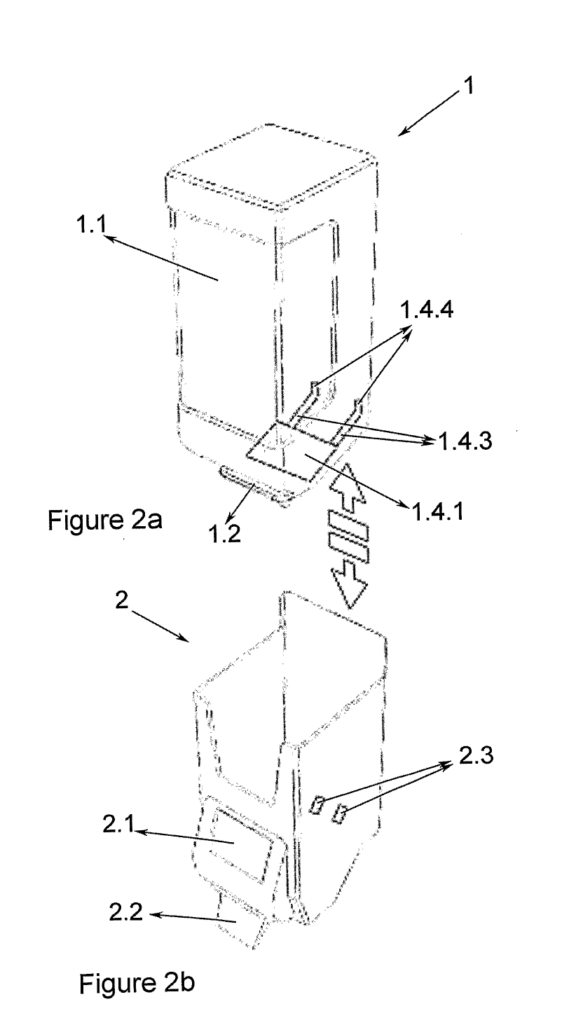

As it can be seen in FIG. 2, the food storage compartment (1) is settled in a compartment slot (2). And the compartment slot (2) comprises electrical connection slots (2.3) in order to provide electrical connection with the connection ends (1.4.4) of the quantity sensor (1.4) that is preferably positioned in the compartment (1), comprises an etiquette field (2.1) where an informative etiquette about the type of the food can be placed, a control member (2.2) preferably embodied in the shape of a latch, which allows the food to be taken out, and food egress (2.4), which allows the food to be taken out through control member (2.2).

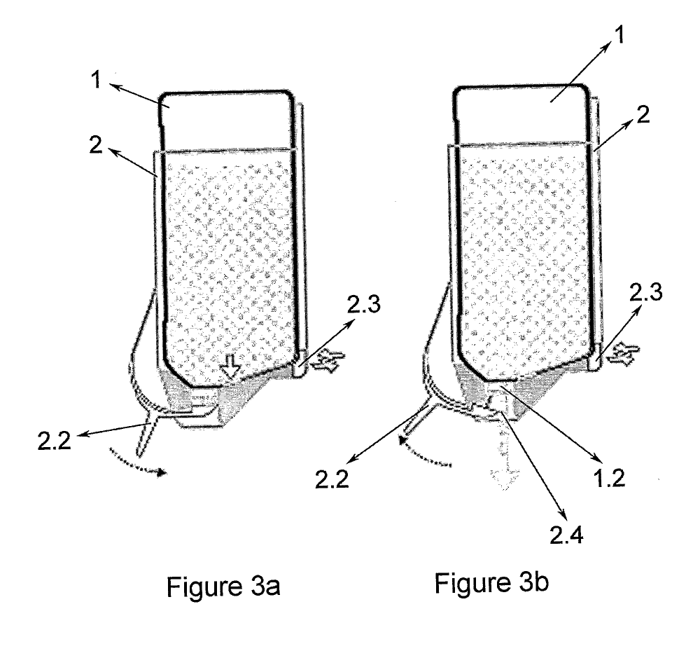

In the cross-sectional view in FIG. 3, it is shown that how the food stuff in a full compartment (1) is taken out through the said control member (2.2). When the control member (2.2), which is preferably embodied in the shape of a latch, is preferably moved towards the front side of the compartment (1) by the user, the food egress (2.4) is opened and food is allowed to go out. The said latch (2.2) preferably comprises a spring mechanism and when released, it automatically closes the food egress (2.4).

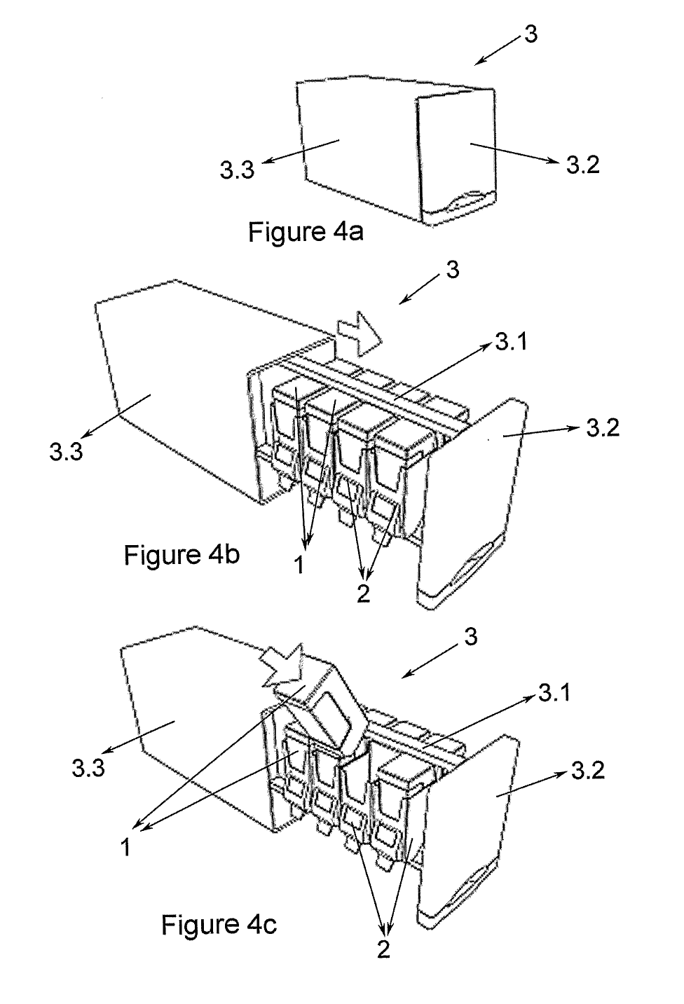

In FIG. 4, a preferred embodiment of a storage mechanism (3) that is formed by positioning of more than one compartment (1) and compartment slot (2), side by side and at the back of each other, by storage mechanism is shown. The storage mechanism (3) is embodied preferably as in the shape of a drawer. However, different embodiments are also possible. In this preferred embodiment, all of the compartment slots (2) are mantled on the compartment slot connection member (3.1), which is positioned in the middle of the drawer perpendicularly. In this way, it is possible to position the compartment slots (2) side by side or at the back of each other. A cover (3.2) is attached on the front side in order to provide both wholeness with the cooling unit or the environment, and to provide forward-backward movement of the compartment slot connection member (3.1). All the compartments (1) can be included in a body (3.3) by the help of a pulling-pushing space that is opened on the cover (3.2) to take the hand inside. The said body (1) preferably comprises cooling members and allows the food stuff in all of the compartments (1) to be kept in cool media. Each compartment (1) can be separately removed from the compartment slots (2) practically, and the food can be filled through the compartment opening (1.2), which is the only opening. After the said opening (1.2) is closed with the compartment opening stopper (1.3), compartment (1) is reversed and can be settled into the compartment slot (2). After filling the compartments (1) as desired, they are dragged to their place by cover (3.2) and settled in the body (3.3).

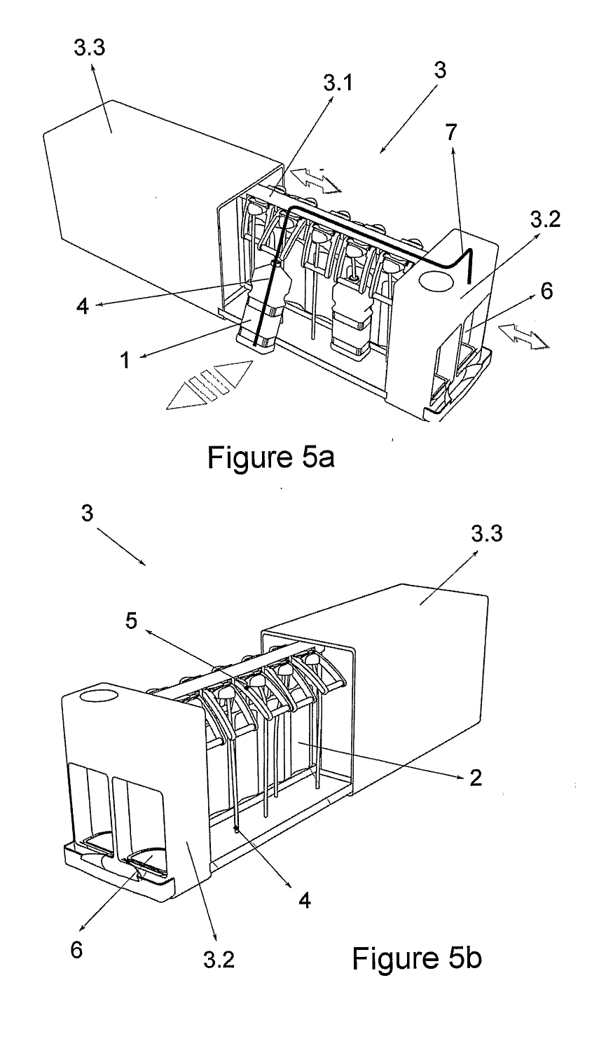

The picture related to the storage and presentation mechanism of liquid food stuff such as oil etc., which is another application and embodiment of the invention, can be seen in FIG. 5a and FIG. 5b. In the said applications, in a preferred area of the cooling unit, a body (3.3) is embodied. A body cover (3.2) is positioned on the body (3.3) through a sliding mechanism.

The said cover (3.2) can move forward˜backward on the slot. Many compartment slots (2) are formed on the said cover (3.2). On each slot (2) over each compartment slot (2), a fixing latch (5) is constructed to fix the product or compartment (1).

Product presentation compartment (6) where the product is presented to the consumer is placed on the front side of the body cover (3.2). The connection between the compartment slot (2) and presentation compartment (6) is done with a liquid discharge channel (4). One end of the liquid discharge channel (4) is positioned in the compartment or the product (1) that is settled in the compartment or product slot (2).

The product (1) that has been introduced to the control unit is positioned in the product slot (2) and the product (6) is settled in its package through transfer pipe or liquid discharge channel (4). Through the said transfer pipe (4), the packaged liquid oil is passed to the presentation compartment (6). The food stuff is taken into the presentation pot, which is inside of the product or compartment (1) through a control member or a tap (2.2) on the product presentation compartment (6).

Whenever a compartment (1) is filled with a food stuff, an electrical signal is produced in the quantity sensor (1.4) on the base, to determine the fullness of the compartment (1). Here, by the insulator member (1.4.2) that is positioned between two conductive panels (1.4.1), the pressure that food applies on the base of the compartment (1) and thus the amount of fullness can be determined. When the compartment (1) is filled fully, the pressure applied will be more and the resistances of the conductive panels reduce, and the amount of electrical current in the circuits that they are connected rise respectively. As the food stuff is discharged from the compartment (1), the pressure applied to the base, thus to the quantity sensor (1.4) decreases. And this will increase the resistance so the current passing through the two ends will decrease in the same rate. Therefore, a change in the electrical current directly proportional to the pressure applied can be obtained in the connection ends (1.4.4) of the quantity sensor through the conductive bands (1.4.3) in this preferred type of embodiment that is used to measure the quantity. Thus, by a control unit in the cooling unit or in the system, this data can be converted to quantity data. The user can determine the amount of food stuff left in the compartments (1) using this data, which can be reflected in a screen.

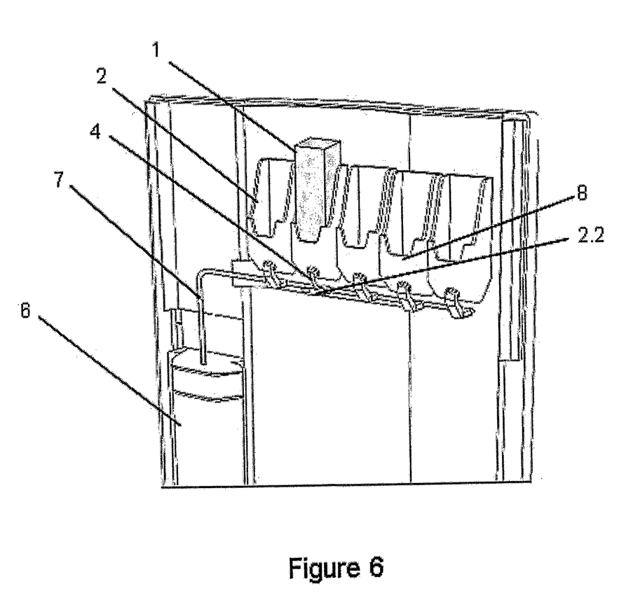

In FIG. 6, a picture of the liquid storage and presentation mechanism in cooling units or in closed media that the invention is applied on, is shown. In the said application, there are many compartment slot (2) formed on the body of the cooling unit.

Liquid transfer channel (4) is positioned in the holes opened on the said slots (2). The said liquid transfer channel (4) is connected to the liquid discharge channel (7). A control member (2.2) is constructed on the connection point of the liquid to discharge channel (7) and the liquid transfer channel (4). The said control member (2.2) supervises the liquid transfer from the liquid transfer channel (4) to liquid discharge channel (7). The liquid discharge channel (7) is connected to the tap in the product presentation compartment (6). The products that are to be presented are positioned into the slots (2) in a package or storage compartment (1). When the product package or storage compartment (1) is placed in the slot (2), liquid transfer channel (4) is positioned on the opening on the package or compartment (1).

When the product package or compartment (1) that is already introduced to the control unit of the cooling unit is placed in the slot (2), the information lamp (8) that is constructed on the slot (2) becomes active. When the expiration date of the product approaches or comes, lamp (8) warns the user by flashing. A mixture can be obtained by transferring the various fruit juices or drinks that are placed in multiple slots (2) in desired amounts, to the discharge or mixing channel (7).

The extent of the protection of this application is specified in the claims section, and it cannot be restricted to the representative application given above in this section. It is obvious that an skilled person in the art may introduce the changes brought by the invention using similar structures and/or may apply those in other fields. Therefore, it is also obvious that those kinds of structures will lack of the criterion that is about improving the present technique.

1. A mechanism for food stuff especially to store in cooling units, comprising:
at least one food storage compartment,
at least one compartment slot in order to attach and de-attach the said food storage compartment to said storage mechanism,
at least one compartment opening in order to fill and take out the food staff to the said compartment, and
at least one control member in order to take the food stuff out of the compartment easily.

2. The storage mechanism according to claim 1, further comprising at least one compartment opening stopper wherein after the food storage compartment is filled, the opening of said food storage compartment is closed with the opening stopper and the food storage compartment is will be settled in said compartment slot in a reversed position.

3. The storage mechanism according to claim 1, further comprising a quantity sensor in order to determine the amount of food put inside the compartment.

4. The storage mechanism according to claim 3, wherein the quantity sensor is formed by placing at least one insulator between at least two conductor panels.

5. The storage mechanism according to claim 3, wherein the quantity sensor produces an alternating electric current depending on the pressure that the food applies in the compartment, and comprises connection ends in order to sense the changes in the said electric current.

6. The storage mechanism according to claim 3, further comprising electrical connection slots that are for the connection ends of said quantity sensor and that transmit the electrical information obtained to the related units of the cooling unit.

7. The storage mechanism according to claim 1, further comprising at least one food egress in said compartment slot and an electric mechanism that opens or closes the food egress when said control member is pushed or pulled.

8. The storage mechanism according to claim 1, wherein a liquid transfer channel is to be placed in said food storage compartment in order to take liquid food stuff by pumping, and said food storage compartment is settled into the compartment slot in a way that it is fixed by using a fixing handle.

9. The storage mechanism according to claim 8, wherein the said control member is connected to said liquid transfer channel for the liquid food stuff.

10. The storage mechanism according to claim 1, further comprising at least one liquid discharge channel which is connected to the control member at one end and is connected a product presentation compartment at the other end.

11. The storage mechanism according to claim 1, further comprising a storing mechanism that allows a number of distribution compartments to be stored, preferably in the cooling unit, side by side or back of each other.

12. The storage mechanism according to claim 11, further comprising at least one compartment slot connection member on which the said compartment slots can be positioned in desired order.

13. The storage mechanism according to claim 12, further comprising a cover which is positioned in front of the compartment slot connection member, and which constitutes the external appearance of the unit, and comprises at least one body, which allows the storing mechanism to be positioned in the cooling unit and allow it to work as a separate unit when desired.

14. The food storage mechanism according to claim 1, further comprising at least one information lamp that is positioned on the compartment and/or compartment slot in order to inform the user by warning light about the expiration date of the product.
